(19) United States
(12) Patent Application Publication
(10) Pub. No.: US 2012/0217170 A1
(43) Pub. Date: Aug. 30, 2012

(54) APPARATUS AND METHOD FOR REMOVAL OF IONS

(75) Inventors: Albert Van Der Wal, Oegstgeest (NL); Hank Robert Reinhoudt, Delft (NL); Freddie Kerpels, Hoogvliet (NL)

(73) Assignee: VOLTEA B.V., Sassenheim (NL)

(21) Appl. No.: 13/504,752

(22) PCT Filed: Nov. 3, 2010
(86) PCT No.: PCT/NL2010/050733

§ 371 Date: Apr. 27, 2012

(30) Foreign Application Priority Data
Nov. 4, 2009 (EP) 09175026.5

(51) Int. Cl. C02F 1/461; C25B 15/02; C25B 9/00

(52) U.S. Cl. 205/743; 204/275.1; 204/228.1; 205/742; 204/230.2

(57) ABSTRACT

An apparatus to remove ions, the apparatus comprising an inlet to let water in the apparatus, an outlet to let water out of the apparatus, a capacitor, and a spacer to separate a first and a second electrode of the capacitor and to allow water to flow in between the electrodes. The apparatus comprises a regeneration mode controller configured to control, during a regeneration mode in which ions previously attracted to the capacitor are released in a waste water stream, one or more of: the electrical current flowing to the capacitor; the voltage on the capacitor; and/or the water flowing in between the electrodes. The regeneration mode controller is constructed and arranged to control one or more of the electrical current, the voltage, and/or the water flow during the regeneration mode such that scaling is reduced or minimized in the apparatus.

### FIELD

An apparatus to remove ions, the apparatus comprising an inlet to let water in the apparatus, an outlet to let water out of the apparatus, a capacitor, and a spacer to separate a first and a second electrode of the capacitor and to allow water to flow in between the electrodes.

### BACKGROUND

In recent years one has become increasingly aware of the impact of human activities on the environment and the negative consequences this may have. Ways to reduce, reuse and recycle resources are becoming more important. In particular, clean water is becoming a scarce commodity. Therefore, various methods and devices for purifying water have been published.

A method for water ion removal is by capacitive deionisation, using an apparatus provided with a flow through capacitor (FTC) for removal of ions in water. The FTC functions as an electrically regenerable cell for capacitive deionisation. By charging electrodes, ions are removed from an electrolyte and are held in electric double layers at the electrodes. The electrodes can be (partially) electrically regenerated to desorb such previously removed ions without adding chemicals.

The apparatus to remove ions comprises one or more pairs of spaced apart electrodes (a cathode and an anode) and one or more spacers, separating the electrodes, allowing water to flow between the electrodes. The electrodes may be made from a high surface area electrically conducting material such as activated carbon, carbon black, a carbon aerogel, carbon nano fiber, carbon nano tubes, graphene or one or more mixtures thereof. The electrodes may be placed as a separate layer on top of a current collector or may alternatively be coated directly onto the current collector. A current collector is made from an electrically conductive material and allows the transport of charge in and out of the electrode.

The apparatus has a housing comprising an inlet to let water in the housing and an outlet to let water out of the housing. In the housing, layers of current collectors, electrodes and spacers may be stacked in a “sandwich” fashion or spirally wound by a compressive force, normally by mechanical fastening.

A charge barrier may be placed between the electrode and the spacer, the term charge barrier referring to a layer of material, which can hold an electric charge and which is permeable or semi-permeable for ions. Ions with the same charge signs as that in the charge barrier mostly cannot pass the charge barrier. Therefore, ions which are present in the electrode compartment adjacent to the charge barrier and which have the same charge sign as the charge in the charge barrier, are retained or trapped in the electrode compartment. A charge barrier may allow an increase in ion removal efficiency as well as a reduction in the overall energy consumption for ion removal.

Once the electrodes of the capacitor become saturated with ions during ion removal the capacitor may be regenerated by going to a regeneration mode by shunting the electrodes or even reversing the polarity of the electrodes. Ions that were previously adsorbed in the electrical double layer at the electrodes are released from the electrode into the water flowing in between the electrodes, e.g. through the spacer. The water may be directed to a waste water output until substantially all the ions are released, then the capacitor is ready for ion removal again.

### SUMMARY

The ions released by the electrodes may comprise hardness ions such as calcium and alkalinity ions such as carbonate and bicarbonate ions. If the concentration of these ions in the waste water becomes too high these ions can precipitate and form scaling. Scaling in a FTC module may clog up the water flow path and possibly also contaminate the electrodes, particularly the cathode. This may negatively influence the performance of a FTC module or even cause the FTC module to stop working.

It is desirable, for example, to make the apparatus for ion removal less sensitive to scaling.

According to a first embodiment of the invention there is provided an apparatus to remove ions, the apparatus comprising:

an inlet to let water in the apparatus;

an outlet to let water out of the apparatus;

a capacitor;

a spacer to separate a first and a second electrode of the capacitor and to allow water to flow in between the electrodes; and

a regeneration mode controller configured to control, during a regeneration mode in which ions previously attracted to the capacitor are released in a waste water stream, one or more of:

the electrical current flowing to the capacitor;

the voltage on the capacitor; and/or

the water flowing in between the electrodes, the regeneration mode controller being constructed and arranged to control one or more of the current flow, the voltage, and/or the water flow during the regeneration mode, desirably such that scaling is reduced or minimized in the apparatus.

An embodiment of the present invention also relates to a method of removal of ions wherein use is made of the apparatus.

According to a further embodiment of the invention, there is provided a method of operating an apparatus to remove ions, wherein the apparatus comprises a capacitor and a housing, the method comprising:

allowing water to enter the housing via an inlet;

allowing the water to flow in between a first and a second electrode of a capacitor to an outlet of the housing; and

during an ion removal mode:

charging the capacitor by connecting the capacitor to a power source, and

removing ions from the water by attracting the ions to the first and/or second electrodes; and

during a regeneration mode:

releasing ions from the electrodes to the water in between the electrodes while controlling one or more of the current flow through the capacitor, the voltage on the capacitor, and/or the water flowing through the capacitor during the regeneration mode, desirably such that scaling is reduced or minimized in the apparatus.

These and other aspects, features and advantages will become apparent to those of ordinary skill in the art from reading the following detailed description and the appended claims. For the avoidance of doubt, any feature of one aspect of the present invention may be utilised in any other aspect of the invention. It is noted that the examples given in the description below are intended to clarify the invention and are not intended to limit the invention to those examples per se. Similarly, all percentages are weight/weight percentages unless otherwise indicated. Numerical ranges expressed in the format “from x to y” are understood to include x and y. When for a specific feature multiple preferred ranges are described in the format “from x to y”, it is understood that all ranges combining the different endpoints are also contemplated.

### BRIEF DESCRIPTION OF THE FIGURES

Embodiments of the invention will be described, by way of example only, with reference to the accompanying schematic drawings in which corresponding reference symbols indicate corresponding parts, and in which:

FIG. 1 shows a cross-section of an apparatus to remove ions;

FIG. 2 shows schematically how the apparatus of FIG. 1 can be controlled;

FIGS. 3a-3d shows the voltage on the capacitor and the conductivity of the waste water during tests 1 to 4;

FIG. 4 shows the molar ratio of calcium and alkalinity during tests 1 to 4;

FIGS. 5a to 5d show the Langelier Saturation Index (LSI) profile during tests 1 to 4; and

FIG. 6 shows the results of test 5 (durability test).

### DETAILED DESCRIPTION

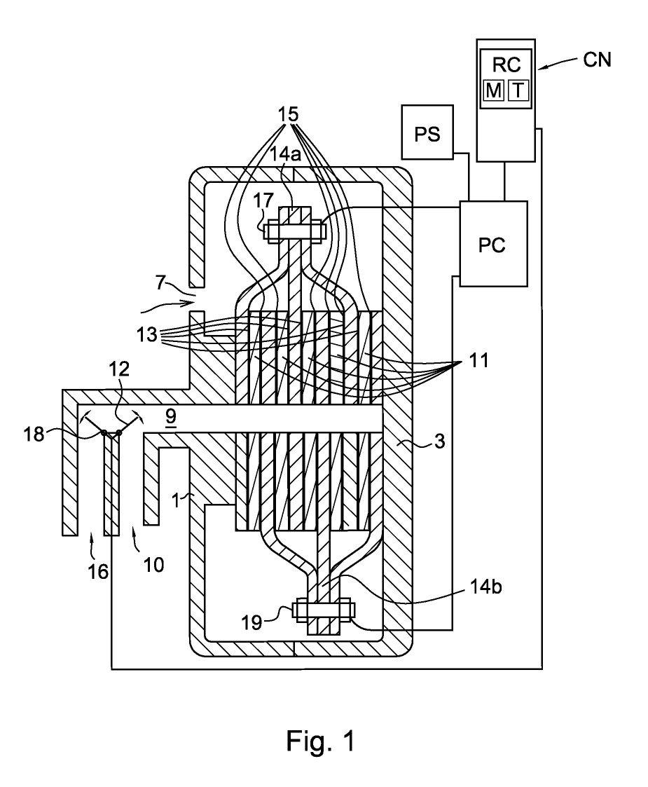

FIG. 1 shows a schematic cross-section of an apparatus to remove ions according to an embodiment of the invention. The apparatus has a housing with a water inlet 7 and a water outlet 9. The housing may be made of a relatively hard material e.g. a hard plastic. Here the housing is composed of a first housing part 1 and a second housing part 3. By assembling, e.g. pressing, the first and second housing parts on each other, for example with a bolt and nut or welding (not shown), the housing is made water tight.

In the housing a flow through capacitor (FTC) is arranged, at least including a pair of spaced apart electrodes, here first electrode 13 and a second electrode 15. A spacer 11 is arranged to separate the electrodes 13, 15 of the flow through capacitor (FTC) and allow for water flow in between the electrodes 13, 15.

During removal of ions from the water, the water flows from the inlet 7 to the outlet 9 through the space between a first electrode 13 and a second electrode 15.

The current collectors 14a and 14b are arranged, here clamped, within the housing and connected to a power converter PC. By creating an electrical potential difference between the first and second electrodes by a power converter PC, for example by applying a positive voltage to the first electrode (the anode) 13 and a negative voltage to the second electrode (cathode) 15 the anions of the water flowing in between the electrodes, e.g. through the spacer 11, are attracted to the first electrode and the cations are attracted to the second electrode. In this way the ions (anions and cations) will be removed from the water flow. The purified water may be discharged to the purified water outlet 10 by the valve 12.

Once the electrodes are saturated with ions the electrodes 13, 15 are regenerated, whereby the ions are released into the water in between the electrodes 13, 15. The water with the increased ion content is flushed away by closing purified water outlet 10 with valve 12 under control of the controller CN and opening waste water outlet 16. Once most ions are released from the electrodes and the water with increased ion content is flushed away via the waste water outlet 16 the electrodes are regenerated and can be used again to attract ions. The controller may be provided with a regeneration mode controller RC comprising a memory M and a timer T.

A power converter PC under control of the controller CN is used to convert the power from the power source PS to the right electrical potential. The electrical potential differences between the anode and the cathode are rather low, for example lower than 12 Volts, lower than 6 Volts, lower than 2 Volts or less than 1.5 Volts.

It is desirable that the electrical resistance of the electrical circuit is low. For this purpose, current collectors 14a which are in direct contact with the first electrodes are connected to each other with a first connector 17 and current collectors 14b which are in direct contact with the second electrodes are connected to each other with a second connector 19.

The current collectors 14a and 14b may be made substantially metal free to keep them corrosion free in the wet interior of the housing and at the same time cheap enough for mass production.

The electrodes 13, 15 may be produced from a substantially metal free electrically conductive high surface area material, such as activated carbon, carbon black, carbon aerogel, carbon nano fiber, carbon nano tubes, graphene or a mixture of one or more of the foregoing, which is placed on both sides of the current collector. The high surface area layer is a layer with a high surface area in square meters per weight of material, for example more than 500 square meters per gram of material. This set-up may help ensure that the capacitor works as an electrical double layer capacitor with sufficient ion storage capacity. The overall surface area of even a thin layer of such a material is many times larger than a traditional material like aluminum or stainless steel, allowing many more charged species such as ions to be stored in the electrode material. The ion removal capacity of the apparatus is thereby increased.

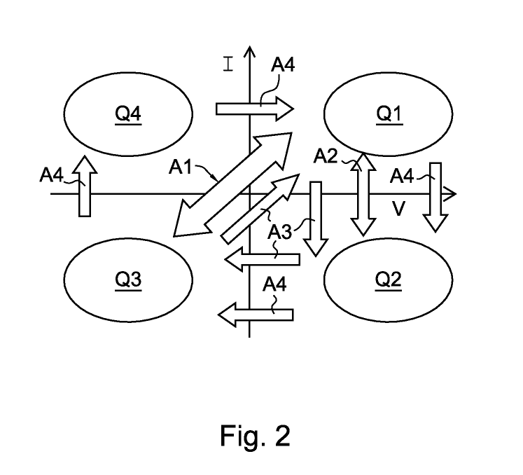

FIG. 2 shows schematically how the apparatus to remove ions can be operated. During ion removal mode Q1 the electrical double layer capacitor is charged at a positive voltage V and with a positive current I. Ions are extracted from the water and once the electrodes of the capacitor become saturated with ions the capacitor may be regenerated by going in one step to the regeneration mode Q3 by reversing the polarity of the electrodes by applying a negative voltage with a negative current. After the ions are released from the electrode, then the capacitor is ready for ion removal in mode Q1 again. Running the flow through capacitor this way is depicted by the arrow A1.

Alternatively, the capacitor may be regenerated by shunting the electrical circuit, which results in a negative current in the first electrode regeneration mode Q2. The energy that is released during the first electrode regeneration mode Q2 can be recovered and returned to the power source in a first energy recovery mode. This may help to reduce the overall energy consumption of the apparatus to remove ions. After the first electrode regeneration mode Q2, the capacitor may be used in the ion removal mode Q1 again. Running the flow through capacitor in this way is depicted by the arrow A2.

After the first electrode regeneration mode Q2, the electrodes may be further regenerated in a second electrode regeneration mode Q3 by applying a negative voltage, which results in a negative current and a further release of ions. After the ions are released from the electrode, then the capacitor is ready for ion removal in mode Q1 again. Running the flow through capacitor this way is depicted by the arrows A3.

After the second electrode regeneration mode Q3 the energy stored on the capacitor during the second regeneration mode Q3 may be recovered to the power source in a second energy recovery mode Q4. This full cycle which includes the ion removal mode, the first electrode regeneration mode/the first energy recovery mode, the second electrode regeneration mode and the second energy recovery mode is depicted by the arrows A4. The flow through capacitor may be provided with a valve 12 (in FIG. 1) to facilitate the discharge of the waste water during the first electrode regeneration mode Q2 and the second electrode regeneration mode Q3 into a waste water outlet 16. During ion removal Q1 the water valve 12 will be switched such that the water will go to a purified water outlet 10.

In the first and the second electrode regeneration modes the concentration of calcium and carbonate ions in the waste water may increase and if the concentration of these ions in the waste water becomes too high these ions can precipitate and form scaling. The controller CN may therefore be provided with a regeneration mode controller RC constructed and arranged to control the current flow, the voltage, and/or the water flow during the regeneration mode such that the Langelier Saturation Index (LSI) in the waste water is below or close to a certain LSI threshold value. In an embodiment, this threshold value is below 3, below 2, below 1, or below 0.5. The Langelier Saturation Index (sometimes the Langelier Stability or Scaling Index) is a calculated number used to predict the calcium carbonate stability of the waste water. It indicates whether the waste water will precipitate, dissolve, or be in equilibrium with calcium carbonate. Langelier developed a method for predicting the pH at which water is saturated in calcium carbonate (called pHs). The LSI is expressed as the difference between the actual system pH and the saturation pH.

LSI=pH−pHs

If the actual pH of the water is below the calculated saturation pH, the LSI is negative and the water has little or no scaling potential. If the actual pH exceeds pHs, the LSI is positive, the water is supersaturated with CaCO₃, and the water has a tendency to form calcium carbonate scale. At increasing positive index values, the scaling potential increases.
For LSI>0, water is super saturated and tends to precipitate CaCO₃.
For LSI=0, water is saturated (in equilibrium) with CaCO₃. CaCO₃ is essentially neither precipitated nor dissolved.
For LSI<0, water is under saturated and tends to dissolve solid CaCO₃.

In practice, water with an LSI between −0.5 and +0.5 will not display enhanced mineral dissolving or scale forming properties. Water with an LSI below −0.5 tends to exhibit noticeably increased dissolving abilities while water with an LSI above +0.5 tends to exhibit noticeably increased scale forming properties. The LSI is temperature sensitive and becomes more positive as the water temperature increases.

The regeneration mode controller RC may be constructed and arranged to the current flow, the voltage, and/or the water flow during the regeneration mode such that the Langelier Scaling Index in the waste water is below a LSI threshold value of 2, 1.5, 1, or 0.5. If the LSI of the waste water stays below the above mentioned threshold values scaling in the FTC is reduced or minimized.

The electrical current during the regeneration mode may be controlled by the regeneration mode controller RC such that the current will be lower than a threshold current so as to keep the Langelier Saturation Index in the waste water below the LSI threshold value. The threshold current may be stored in the memory M and compared with the actual current by the regeneration mode controller RC and the actual current may be adjusted to a value below the threshold current. The threshold current may be calibrated by measuring the Langelier Saturation Index of the waste water and adjusting the electrical current through the capacitor such that the LSI is below the LSI threshold value of 2, 1.5, 1, or 0.5 and storing the adjusted current in the memory as the threshold current. By controlling the current during regeneration to below the threshold current the LSI of the waste water can be kept below the LSI threshold value.

The apparatus may have a valve 18 controlled by the regeneration mode controller RC to control the amount of waste water directed to waste water output 16 during the regeneration mode such that scaling is reduced or minimized in the apparatus. The regeneration mode controller RC may control both the current and the water flow through the capacitor to keep the LSI value of the water below the threshold values.

The regeneration mode controller RC may control the voltage during the regeneration mode such that the voltage will follow a controlled voltage profile so as to keep the Langelier Scaling Index in the waste water below a LSI threshold value. The controlled voltage profile may follow a pre-described mathematical function, for example a predetermined stepwise voltage profile or a gradually decreasing voltage profile as a function of time, for example an exponentionally decaying voltage profile. The controller may therefore be provided with a memory M to store the threshold voltage profile and with a timer T to make it possible to follow the threshold voltage profile if it is dependent on the time. The threshold voltage profile may be dependent on the waste water which has flowed through the flow through capacitor of the apparatus or the current flow through the capacitor. In both cases the regeneration mode controller RC may be connected to a pump speed controller or a measurement system to measure the waste water flow through the capacitor or the electrical current to and from the capacitor in the regeneration mode.

The apparatus may have a valve 18 controlled by the regeneration mode controller RC to control the amount of waste water directed to a waste water output 16 during the regeneration mode to be larger than a threshold waste water flow such that scaling is reduced or minimized in the apparatus. The memory M may store the waste water threshold.

During use the apparatus may be operated by:

allowing water to enter the housing via the inlet 7;

allowing the water to flow in between a first and a second electrode 13, 15 of the capacitor to an outlet 9 provided in the housing 1, 3, and

during ion removal mode:

charging the capacitor by connecting the capacitor to a power source PS via a power converter PC configured to convert a supply voltage of the power source PS to a charging voltage, and

removing ions from the water by attracting the ions to the first and/or second electrodes 13, 15; and

during a regeneration mode:

releasing ions from the electrodes 13, 15 into the water in between the electrodes while controlling current flow through the capacitor, the voltage on the capacitor, and/or the water flowing through the capacitor during the regeneration mode such that scaling is reduced or minimized in the apparatus.

The regeneration mode controller RC may also be connected to one or more sensors configured to measure online, for example the pH, the calcium concentration, temperature and/or one or more other relevant parameters, in the waste water. The data may be used to determine the LSI in the waste stream and to alter the LSI by varying for example the current, the voltage and/or the flow through the FTC module.

The regeneration mode controller RC or controller CN may control a maintenance cycle to reduce or minimize scaling in the FTC. One or more of the electrical current, the voltage, and/or the water flow during a maintenance cycle may be controlled such that the Langelier Saturation Index (LSI) in the water becomes below a certain LSI corrosive threshold value. The maintenance cycle may comprise purifying water for a long period of time without any water flowing through the FTC. The maintenance controller may for this purpose close the valve 18 or 12 or switch off a pump used to pump the water through the FTC. The purified water would get very clean with the LSI becoming lower than a certain LSI corrosive threshold, for example lower than 0 or lower than −0.5 which is corrosive and may dissolve scaling present in the apparatus. By applying the maintenance cycle once in a while, for example once in 10 to 10000 purifying steps, or once in 100 to 1000 purifying steps, scaling can be cleaned away periodically out of the apparatus.

### EXAMPLES

Experiments are carried out using a FTC module containing 2 stacks, each having 23 repeating unit cells with an unit cell surface area of 226 cm². For tests 1-4 only 90 seconds for the ion removal mode Q1 was used at +1.5 Volts and 60 seconds of regeneration, where the flow rate during regeneration was the same as during purification in order to be able to collect enough samples for the alkalinity, hardness and pH analyses. In those cases the water recovery was only 60%. Samples were taken from the waste stream, immediately after the FTC water outlet, after 0.5 hour and 1 hour operation of the FTC system. All samples were analysed within 1 hour for hardness, alkalinity, pH and conductivity. The alkalinity was measured by a volumetric determination by titration with a strong acid (hydrochloric acid). By adding an indicator to the water the endpoint of the titration was determined by means of a change in color. The quantity of reagent (hydrochloric acid) added until the color changes (at pH 4.3) is a measurement for the alkalinity. The alkalinity test was done with Fluka Aquanal-plus acid capacity (Alkalinity) test set #32017.

Calcium levels were measured by means of a complexometric titration with EDTA. The endpoint of the titration was determined adding a (metallochromic) indicator to the sample. A color change is observed when EDTA replaces the indicator molecule as the ligand in the divalent ion complex. The amount of EDTA added to the sample until a change in color is observed is a measure for the calcium level in the water.

Test 1: The 1^{st} test is with a regeneration cycle with 60 seconds regeneration at reversed polarity and at a voltage of −1.5 V. In order to be able to take enough water samples the flow was set at 1 l/min, the same for purification and regeneration and no concentration step was used.

Test 2: The 2^{nd} test is a modified regeneration cycle, where the voltage is not switched directly to −1.5 V, but first to 0 V, shunt for 40 seconds and then to −1.5 V for 20 seconds.

Test 3: The 3^{rd} test is also an adjusted regeneration cycle, where the voltage was first kept at +0.5 V for 40 seconds and subsequently lowered to −1.5 V for 20 seconds.

Test 4: In the 4^{th} test the regeneration cycle is operated at a constant current of 25 A. In practice the voltage will adapt to the current and gradually decrease with time.

Test 5: A 60 hour durability test at constant current conditions, where the flow during regeneration is at half the level of that during purification, 1 l/min and 0.5 l/min for 120 seconds and 60 seconds respectively. The water recovery under those conditions is 80%.

Feed water was prepared based on IEC 60734 (Ca only)

| | |
|---|---|
| Conductivity | 0.980 mS/cm |
| Temperature | 21° C. |
| pH | 7.8 |
| Composition | Ca: 3.0 mmol (120 ppm); HCO₃: 4.5 mmol/l (275 ppm) |
| | Total Hardness: 30 FH |

### On-line Measurements

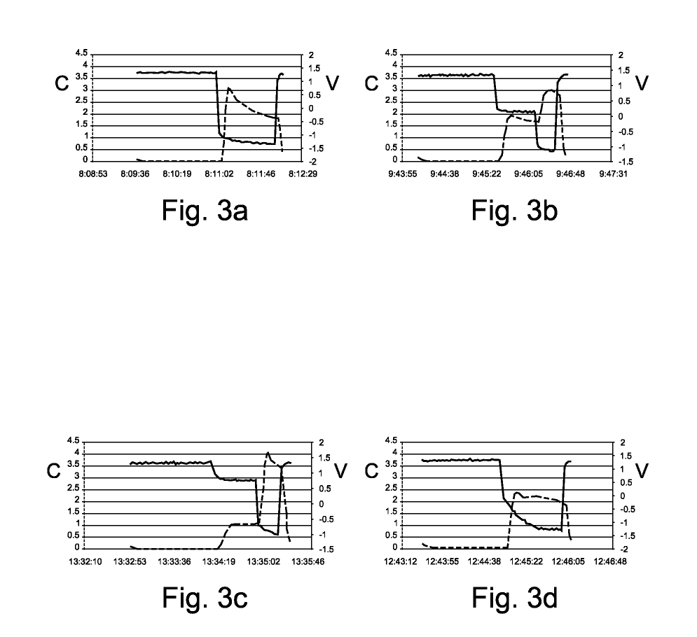

FIGS. 3a to 3d show the conductivity and voltage profiles for a complete cycle. The solid lines are the applied voltage profiles and plotted on the second y-axis with a V. The dashed lines are the conductivity measurements measured at the waste water outlet 16 in FIG. 1 of the FTC module and plotted on the first Y-axis with a C.

FIG. 3a shows the voltage and conductivity profile of test 1, the solid line depicting that the voltage drops to almost −1.5 V after 8:11 and the dashed line depicting the conductivity showing an initial peak release of ions during regeneration at 3 mS/cm, followed by a gradual decrease. In FIG. 3b (test 2) the solid line of the voltage decreases first to 0 V after 9:45 and after 40 seconds drops further in the direction of −1.5V. The release of ions follows the voltage curve, the conductivity is first around 2 mS/cm and after 40 seconds the conductivity increases to 3 mS/cm.

In FIG. 3c (test 3) the solid line shows that the voltage is first switched from almost 1.5 V to +0.5 V for 40 seconds and then decreased into the direction of the value −1.5 V just before 13:35. During the +0.5V step the release of ions is lower, compared to test 2, conductivity (˜1 mS/cm). Also a peak release in the second step (switch to −1.5 V) can be observed.

Finally, FIG. 3d (test 4) shows a situation where constant current is used for the regeneration cycle and shows no peak release of ions. In this same graph it can also be observed that the voltage gradually decreases in order to maintain the current at 25 A (constant current regeneration).

### Off-line Batch Sampling

Samples are taken during the regeneration cycle just after the FTC module. Samples are collected during 10 seconds. So, each regeneration cycle (60 seconds) results in 6 samples. All tests were carried out in duplicate. Each sample was analyzed within one hour for pH, conductivity, Ca and alkalinity. The conductivity and pH data are summarized in Table 1.

TABLE 1
Average (n = 2) conductivity and pH results of the waste stream

| time interval | | mean | Test 1 | | Test 2 | | Test 3 | | Test 4 | |
|---|---|---|---|---|---|---|---|---|---|---|
| (s) | | (s) | σ (μS/cm) | pH | σ (μS/cm) | pH | σ (μS/cm) | pH | σ (μS/cm) | pH |
| 0 | 10 | 5 | 1796 | 7.6 | 861 | 7.3 | 359 | 6.7 | 318 | 7.1 |
| 10 | 20 | 15 | 2810 | 7.9 | 1941 | 7.5 | 1054 | 7.2 | 2255 | 7.7 |
| 20 | 30 | 25 | 2415 | 8.0 | 1807 | 7.6 | 1100 | 7.3 | 2280 | 8.0 |
| 30 | 40 | 35 | 2185 | 8.1 | 1721 | 7.6 | 1088 | 7.3 | 2305 | 8.0 |
| 40 | 50 | 45 | 2025 | 8.1 | 2595 | 7.6 | 3085 | 7.4 | 2285 | 8.0 |
| 50 | 60 | 55 | 1902 | 8.1 | 3010 | 7.6 | 3790 | 7.5 | 2180 | 8.1 |

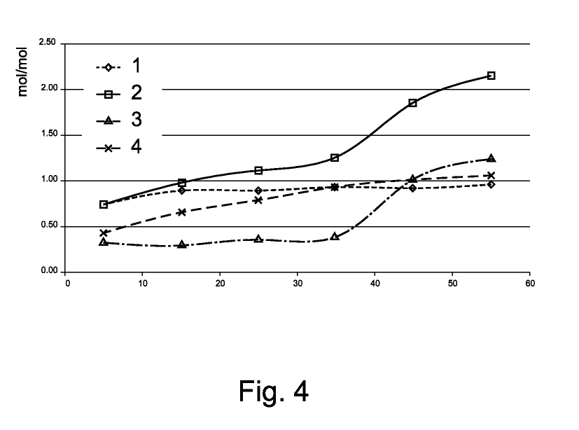

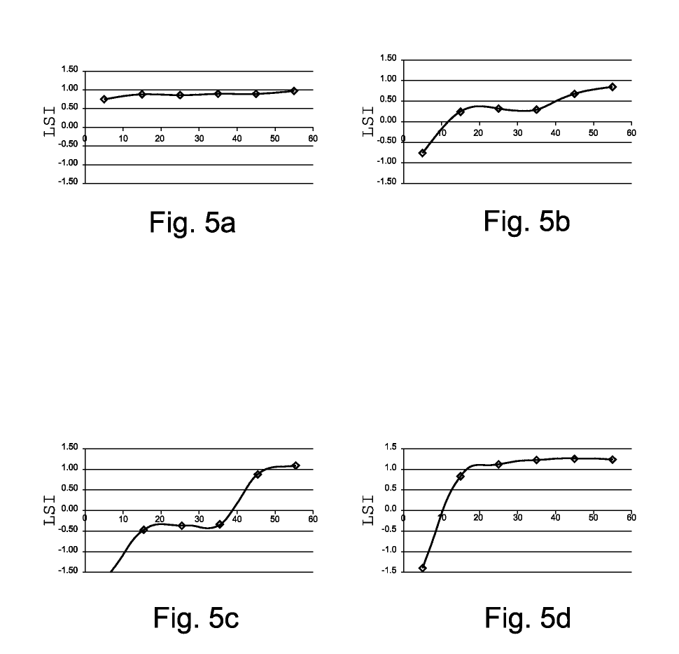

The molar ratio of the alkalinity and calcium are plotted in FIG. 4. From FIG. 4 it can be observed that the ratio between calcium and alkalinity can vary from about 0.5 to 2. This indicates that carbonate ions are released faster from the electrode compartment than calcium ions, especially at lower voltages. Based on the above data the Langelier Scaling Index (LSI) is calculated. The results are shown in FIGS. 5a to 5d.

A LSI of 0 to 0.5 has a slight scale potential, but is normally considered to be a safe zone, whereas at a LSI of 2, scale forming is expected. Under all four test conditions, the LSI during regeneration reaches values of about 1, which means that under the test conditions scale forming in the spacer compartment is manageable.

Although as seen in test 1 (60 seconds @ −1.5 V) that the conductivity, calcium and alkalinity levels decrease with time, FIG. 5a shows a slightly increasing LSI. The main reason for this is the increasing pH value. If the pH increases by 0.5, then under these conditions, the LSI will roughly also increase by 0.5.

Test 5: Durability Test

For the durability test the same setup has been chosen as that for test 4, except that the water recovery was 80%, a longer desalination time of 120 seconds is used and reduced flow of 0.5 l/min is used during regeneration (see below in Table 2).

TABLE 2
FTC settings for the durability test

| Step | Power | Shunt | Inlet | Pure | Waste | Voltage (V) | Current (A) | time (s) | Flow (l/min) |
|---|---|---|---|---|---|---|---|---|---|
| 1 | on | off | on | | on | −1.5 | 30 | 60 | 0.5 |
| 2 | on | off | on | on | | 1.5 | 250 | 120 | 1.0 |

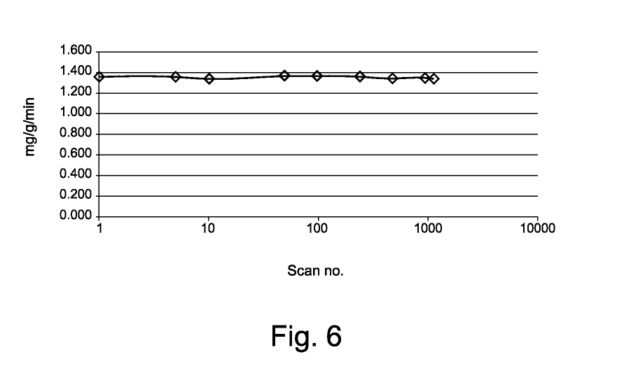

The system has run for 60 hours, which resulted in 1200 purification-regeneration cycles and about 3000 litres of service water. During this period the performance did not decrease and also the cell pressure didn't increase (p=0.25 bar). This is depicted in FIG. 6 as the average deionization rate. The results are expressed as mg ions removed per gram carbon per minute.

While specific embodiments of the invention have been described above, it will be appreciated that the invention may be practiced otherwise than as described. The description is intended to be illustrative, not limiting. Thus, it will be apparent to one skilled in the art that modifications may be made to the invention as described without departing from the scope of the claims set out below.

1. An apparatus to remove ions, the apparatus comprising:
an inlet to let water in the apparatus;
an outlet to let water out of the apparatus;
a capacitor;
a spacer to separate a first and a second electrode of the capacitor and to allow water to flow in between the electrodes; and
a regeneration mode controller configured to control, during a regeneration mode in which ions previously attracted to the capacitor are released in a waste water stream, one or more of:
the electrical current to the capacitor;
the voltage on the capacitor; and/or;
the water flow in between the electrodes.

2. The apparatus according to claim 1, wherein the regeneration mode controller is constructed and arranged to control the electrical current, the voltage, and/or the water flow during the regeneration mode such that the Langelier Saturation Index (LSI) in the waste water is below a certain LSI threshold value.

3. The apparatus according to claim 1, wherein the regeneration mode controller is constructed and arranged to control the electrical current, the voltage, and/or the water flow during the regeneration mode such that the Langelier Saturation Index (LSI) in the waste water is below a LSI threshold value of.

4. The apparatus according to claim 1, wherein the regeneration mode controller is constructed and arranged to control the electrical current during the regeneration mode such that the current will be lower than a threshold current.

5. The apparatus according to claim 1, further comprising a valve, controlled by the regeneration mode controller, constructed and arranged to control the amount of waste water directed to a waste water output during the regeneration mode.

6. The apparatus according to claim 1, wherein the regeneration mode controller is constructed and arranged to control the voltage during the regeneration mode such that the voltage will follow a certain voltage profile.

7. The apparatus according to claim 1, further comprising a valve, controlled by the regeneration mode controller, to control the amount of waste water directed to a waste water output during the regeneration mode to be larger than a waste water threshold.

8. The apparatus according to claim 1, wherein the regeneration mode controller comprises a memory storing (i) a waste water threshold, (ii) a threshold current, (iii) a threshold voltage profile, or (iv) any combination selected from (i)-(iii).

9. The apparatus according to claim 1, wherein the regeneration mode controller is constructed and arranged to control the electrical current, the voltage, and/or the water flow during a maintenance cycle such that the Langelier Saturation Index (LSI) in the water becomes below a certain LSI corrosive threshold value in which scaling present in the apparatus is dissolved.

10. A method of operating an apparatus to remove ions, the apparatus comprising a capacitor and a housing, the method comprising:
allowing water to enter the housing;
allowing the water to flow in between a first and a second electrode of the capacitor to an outlet of the housing;
during an ion removal mode:
charging the capacitor by connecting the capacitor to a power source, and
removing ions from the water by attracting the ions to the first and/or second electrode; and
during a regeneration mode:
releasing ions from the electrodes to water in between the electrodes while controlling one or more of the electrical current through the capacitor, the voltage on the capacitor, and/or the water flowing through the capacitor during the regeneration mode.

11. The method according to claim 10, comprising controlling the electrical current, the voltage, and/or the water flow during the regeneration mode such that the Langelier Saturation Index (LSI) in the waste water is below a LSI threshold value of 3.

12. The method according to claim 10, comprising controlling the electrical current during the regeneration mode such that the current will be lower than a threshold current so as to keep the Langelier Saturation Index (LSI) in the waste water below a LSI threshold value.

13. The method according to claim 10, comprising controlling the voltage during the regeneration mode such that the voltage will follow a certain voltage profile so as to keep the Langelier Saturation Index (LSI) in the waste water below a LSI threshold value.

14. The method according to claim 10, comprising calibrating the apparatus by measuring the Langelier Saturation Index of the waste water and adjusting the electrical current through the capacitor, the voltage on the capacitor, and/or the water flowing through the capacitor using a controller.

15. The method according to claim 10, comprising using one or more sensors to measure one or more online parameters of the waste water and using the data to determine the Langelier Saturation Index (LSI) in the waste stream and to alter the LSI by varying the electrical current, the voltage, and/or the water flow through the apparatus.

16. The method according to claim 10, comprising controlling the amount of waste water directed to a waste water output during the regeneration mode using a valve.

17. The apparatus according to claim 1, wherein the regeneration mode controller is constructed and arranged to control the electrical current, the voltage, and/or the water flow during the regeneration mode such that the Langelier Saturation Index (LSI) in the waste water is below a LSI threshold value of 2.

18. The apparatus according to claim 1, wherein the regeneration mode controller is constructed and arranged to control the electrical current, the voltage, and/or the water flow during the regeneration mode such that the Langelier Saturation Index (LSI) in the waste water is below a LSI threshold value of 1.

19. The apparatus according to claim 1, wherein the regeneration mode controller is constructed and arranged to control the electrical current, the voltage, and/or the water flow during the regeneration mode such that the Langelier Saturation Index (LSI) in the waste water is below a LSI threshold value of 0.5.

20. An apparatus to remove ions, the apparatus comprising:
a capacitor;
a spacer to separate a first and a second electrode of the capacitor and to allow water to flow in between the first and second electrodes; and
a regeneration mode controller configured to control the electrical current to the capacitor, the voltage on the capacitor, and/or the water flow in between the electrodes so as to reduce or minimize scaling in the apparatus during a regeneration mode in which ions previously attracted to the capacitor are released in a waste water stream.

21. The apparatus according to claim 20, wherein the regeneration mode controller is constructed and arranged to control the electrical current, the voltage, and/or the water flow such that the Langelier Saturation Index (LSI) in the waste water is below 3.

22. The apparatus according to claim 20, wherein the regeneration mode controller is configured to control the voltage such that the voltage will follow a certain voltage profile to reduce or minimize the scaling.

23. The apparatus according to claim 20, wherein the regeneration mode controller is configured to control the electrical current, the voltage, and/or the water flow for a maintenance cycle such that the Langelier Saturation Index (LSI) in the water becomes below a certain LSI corrosive threshold value in which scaling present in the apparatus is dissolved.
